(19) United States
(12) Patent Application Publication
(10) Pub. No.: US 2018/0094751 A1
(43) Pub. Date: Apr. 5, 2018

(54) ELEVATED CABLE SUPPORT STRUCTURE

(71) Applicant: Level 3 Communications, LLC, Broomfield, CO (US)

(72) Inventors: Joel S. Skoglund, Brighton, CO (US); Joseph Nguyen, Denver, CO (US)

(73) Assignee: Level 3 Communications, LLC, Broomfield, CO (US)

(21) Appl. No.: 15/282,624

(22) Filed: Sep. 30, 2016

(51) Int. Cl. F16L 3/127; F16M 11/28; F16B 1/00; F16L 3/12

(52) U.S. Cl. CPC F16L 3/127; F16M 11/28; F16B 2001/0035; F16L 3/1218; F16B 1/00

(57) ABSTRACT

A cable support device including a first member for supporting a cable above a floor and a support member for coupling with a safety cone. The first member may include a base portion, a first portion, and a second portion spaced apart from the first portion. The first portion and the second portion may extend upwards from opposite ends of the base portion. The support member may extend downward from the base portion of the first member and may include a bottom portion configured to couple with the safety cone.

### TECHNICAL FIELD

Aspects of the present disclosure involve a cable support structure and more particularly a device for protecting fiber optic cable while it is being installed.

### BACKGROUND

Telecommunication and computer networks frequently use fiber optic cable as an alternative to other cables, such as copper cable, because of its increased bandwidth and speed, among other factors. Fiber optic cable itself is much more fragile than other cables, such as copper cable, because it has a glass core. In a data center, for example, fiber optic cable is often deployed between network devices, such as servers, routers, switches, and the like, and is often supported and held in place by overhead cable racks or under floor tiles.

Given the fragile nature of fiber optic cables, installing the cable in a telecommunication or data center environment poses many challenges. Before the cable is interconnected between various possible network devices or placed in the cable racks, the cable is often staged or laid out on the floor of the data center. By laying out the cable beforehand, it can be easily cut to length and prepositioned to be pulled into the racks without causing excessive damage to the cable. While laying out the cables, it is important to not crush, stress, kink, or otherwise damage the cable. Damaged fiber optic cables may not properly transmit signals and often require replacement. To make matters worse, damaged cable is often only discovered after the cable is installed and connected, thus, requiring additional time for removal and replacement of the damaged cables. During the installation process, the cable is susceptible to being crushed by being stepped on by personnel or run over by moveable equipment as it is laid out on the floor. Additionally, long lengths of cable lying on the floor can present a tripping hazard to personnel. Finally, when lifting cables from the floor to their permanent positions (e.g., overhead cable rack), there is a risk of kinking or bending the cable because of the distance the cable may be raised.

With these thoughts in mind, among others, aspects of the cable support device, disclosed herein, were conceived and developed.

### SUMMARY

Aspects of the present disclosure may involve a cable support device including a first member and a second member. The first member may include a base portion, a first portion, and a second portion spaced apart from the first portion. The first portion and the second portion may extend upwards from opposite ends of the base portion. The support member may downwardly extend from the base portion of the first member and may include a bottom portion configured to couple with a safety cone.

In certain instances, the support member may be height-adjustable.

In certain instances, the support member may further include a moveable rod configured to slide relative to the bottom portion and a clamp that secures the moveable rod at a given height.

In certain instances, the support member may further include tapered telescoping hollow tubes configured to form an interference fit with each other to maintain a given height.

In certain instances, the base portion, the first portion, and the second portion together form a u-shaped structure and partially enclose an area.

In certain instances, the device may further include a second member pivotally connected to the first portion and configured to be secured to the second portion.

In certain instances, the support member may further include a joint configured to move about an axis.

In certain instances, the support member may further include a moveable rod with a plurality of holes positioned longitudinally on the moveable rod, each of the plurality of holes configured to receive a pin, the pin extending beyond a wall of the moveable rod and interfacing with the support member to secure a height of the moveable rod relative to the bottom portion.

In certain instances, the bottom portion of the support member includes an insert receivable in an opening of the safety cone.

In certain instances, the bottom portion of the support member may include a conical structure including a bottom opening configured to receive and overlay a vertex of the safety cone.

In certain instances, the insert is positioned on an inner side of the conical structure.

In certain instances, the insert includes a member having a frustum-shape.

In certain instances, the bottom portion of the support member includes a conical structure including a bottom opening configured to receive and overlay a vertex of the safety cone.

In certain instances, the bottom portion of the support member is coupled to the safety cone by an interference fit.

In certain instances, the first member and the support member may define a substantially planar member.

In certain instances, the bottom portion may include an insert receivable in an opening of the safety cone.

In certain instances, the bottom portion may further include a first and a second slot, the insert positioned between the first and second slot.

In certain instances, the device may further include a second member pivotally connected to the first portion and configured to be secured to the second portion.

### BRIEF DESCRIPTION OF THE FIGURES

FIG. 1 illustrates a cable support structure in a data center.

FIG. 2 is an example embodiment of a cable support structure coupled with a safety cone.

FIG. 3 is a second example embodiment of a cable support structure.

FIG. 4 is a third example embodiment of a cable support structure.

FIG. 5 is an example embodiment of a cable support structure with height adjustment.

FIG. 6 is an example embodiment of a flexible cable cradle.

### DETAILED DESCRIPTION

Aspects of the present disclosure involve a cable support structure for providing temporary support and protection to one or more cables prior to interconnecting the cable between devices. More particularly, the cable support structure provides an elevated support to position a cable above the floor of a server room or other environment, for example, to protect it from damage while also positioning the fragile cable to an intermediate position between the floor and the server racks, for example. Additionally, the cable support structure provides a visual warning to personnel of a tripping hazard. The cable support structure is capable of use with a safety cone and can be used either individually or as part of a system for running cables between various pieces of equipment in a network.

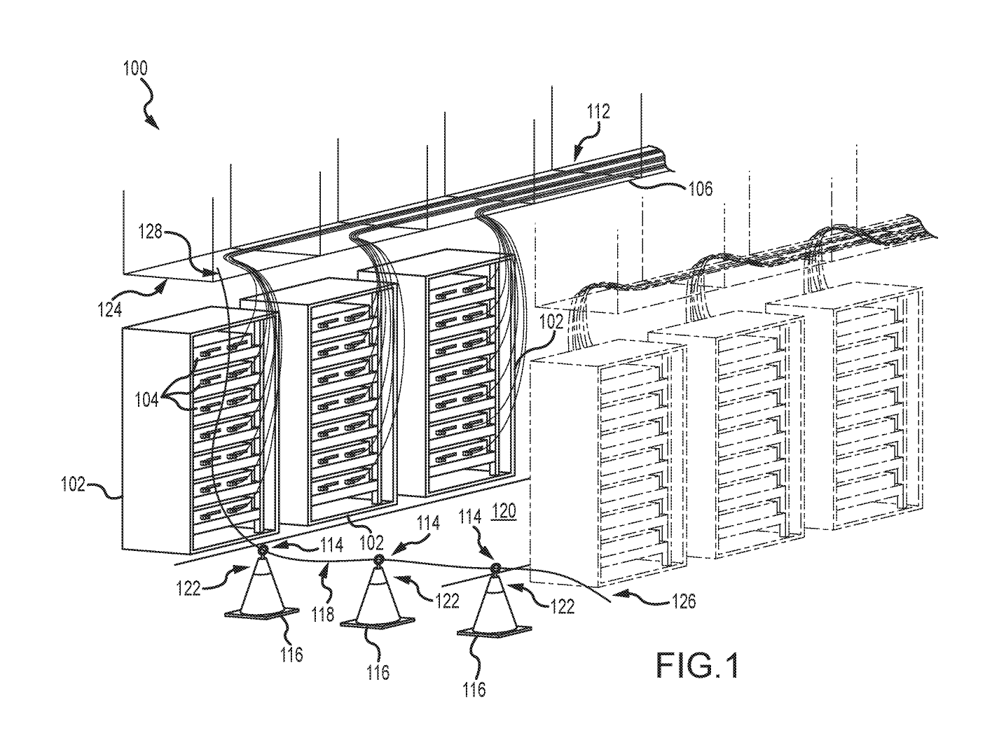

FIG. 1 is an illustration of a portion of a data center room 100 with multiple cable support structures 114 positioned to support a cable 118. The data center 100 may include racks 102 that house devices 104, such as servers, switches, routers, and other computing equipment. There are cable trays 106 positioned above the racks 102 to support cable, fiber, and other means of interconnecting the devices 104 in various racks.

The cable support structure 114 is used to temporarily support and preposition one or more new cables 118 as the cables 118 are being positioned in the rack and connected between devices 104 in the data center 100. FIG. 1 shows each cable support structure 114 attached to an upper end 122 of a respective safety cone 116. The safety cones 116 with the supports 114 connected to the cones 116 are spaced out across the floor 120 of the data center 100 so as to support the cable 118 above the floor 120 of the data center 100.

As seen in FIG. 1, the new cable 118 is supported along a length of the cable 118 from a first end 128 of the cable 118 to a second end 126 of the cable 118 by multiple cable support structures 114 and safety cones 116. The first end 128 of the cable 118 may be successively coupled to or supported by each cable support structure 114 until the first end 128 of the cable 118 reaches a first end 124 of the cable tray 106. This is an exemplary arrangement representative of a cable being positioned to be routed along the tray 106 and connected between devices 104. As seen in the figure, the cable 118 is supported by the cable tray 106 as it extends from the first end 124 to a second end 112 of the cable tray 106. As the cable 118 is pulled from the first end 124 to the second end 112, the cable 118 freely slides through the cable support structures 114 until a second end 126 of the new cable 118 interfaces with a desired device 104. The first end 128 of the cable 118 can then connect or interface with a second device 104, thereby forming a connection between the two devices 104.

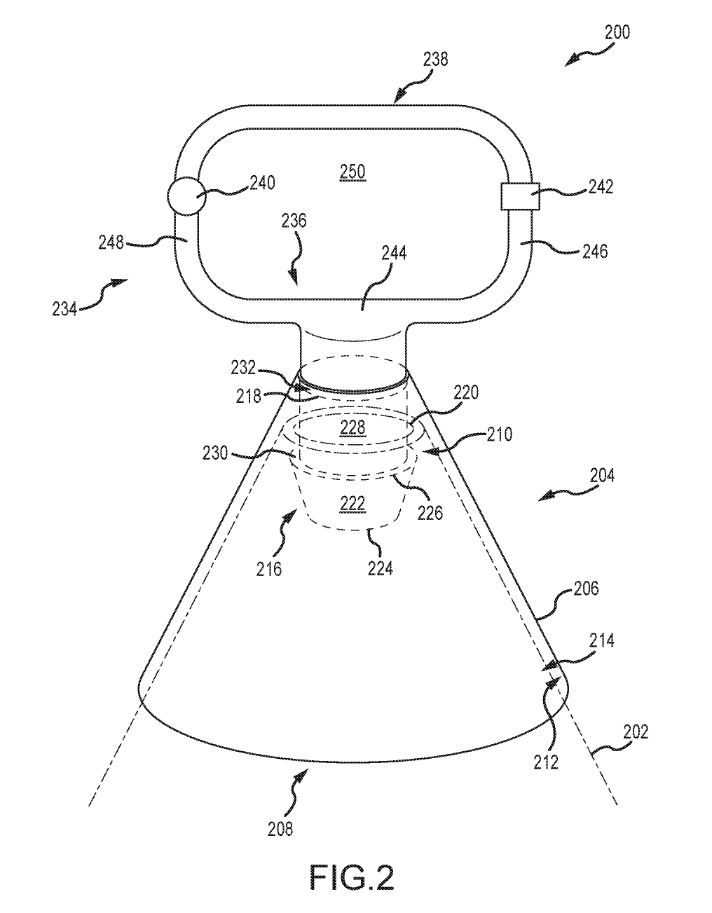

FIG. 2 illustrates an example embodiment of a cable support structure 200 supported on or coupled to a safety cone 202. In certain instances, the cable support structure 200 and safety cone 202 are removably coupled or joined together. In a first embodiment, a base 204 of the support structure 200 may include a truncated hollow cone 206 with an opening at a bottom end 208 that allows the cone to overlay a top or vertex 210 of the safety cone 202 and rest an internal surface 212 of the hollow cone 206 on an external surface 214 of the safety cone 202.

The support structure 200 may also include an insert 216, which extends from an upper internal surface 218 of the hollow cone 206 towards the open bottom end 208 of the cone 206. The insert 216 can be inserted in a top opening 220 of the safety cone 202 such that the internal surface 212 of the hollow cone 206 generally abuts an external surface 214 of the safety cone 202 when the insert 216 is positioned within the top opening 220 of the cone 202. The insert 216 may be made from either a flexible resilient material or a rigid material. The insert 216 may include an end or portion shaped like a frustum 222. The frustum 222 has a cross-sectional area that increases from a smaller bottom end 224 to a larger top end 226. Typically, safety cones define an opening and are flexibly resilient; thus, even a rigid insert with a larger diameter than the opening may be pressed through the opening. The cross-sectional area of the top end 226 is larger than an opening 220 in the safety cone 202 so that some force is required to insert the frustum 222 into the top opening 220 of the safety cone 202. The larger cross-sectional area of the top end 226 also requires some force to pull the frustum 222 free of the opening 220.

At the top end 226 of the frustum 222 there is a post 228 that has a smaller cross-sectional area than the top end 226 of the frustum 222, such that there is a ledge or step 230 to prevent the insert 216 from being pulled back out of the opening 220 of the safety cone 202. The post 228 is connected or joined to an upper end 232 of the hollow cone 206 at a point above the top or vertex 210 of the safety cone 202.

Still referring to FIG. 2, the post 228 extends upwardly from the upper end 232 of the hollow cone 206 and supports a cable cradle 234. The cable cradle 234 may include a lower support 236, a closure 238, a hinge 240, and a latch mechanism 242. The lower support 236 is a U-shaped structure to support and retain one or more cables in the cradle 234. The lower support 236 has a base section 244 and upwardly extending tines 246,248 at either end of the base section 244. The hinge 240 is joined to a first of the two upwardly extending tines 248 and the latch is joined to the second of the two upwardly extending tines 246. The closure 238 may be an inverted U-shape that mirrors the U-shaped lower support 236. The closure 238 is pivotally connected to the lower support 236 at the hinge 240 and is securable at the latch 242 when the closure 238 is pivoted relative the lower support 236. Depending on the height of the tines 246,248, or their configuration, the lower support 236 may be sufficient, without the closure 238, to hold the cable 118. The inner edges of the closure 238 and lower support 236, among other portions of the cable cradle 234, may be rounded or smooth so as to avoid pinching or snagging of the cable as it runs through the cradle 234.

In a closed configuration, the closure 238 and lower support 236 are pivotally connected at the hinge 240 and secured at the latch 242 such that they enclose an area 250. The cables are supported by the lower support 236 and the closure helps retain the cables within the area 250. In an open configuration, the closure 238 and lower support 236 are pivotally connected at the hinge 240 but are not contacting or otherwise coupled at the latch 242. The open configuration allows the support structure 234 to provide support for the cables, but cables can be introduced to the area 250 through a gap between the non-contacting ends of the lower support 236 and closure 238 at the latch 242.

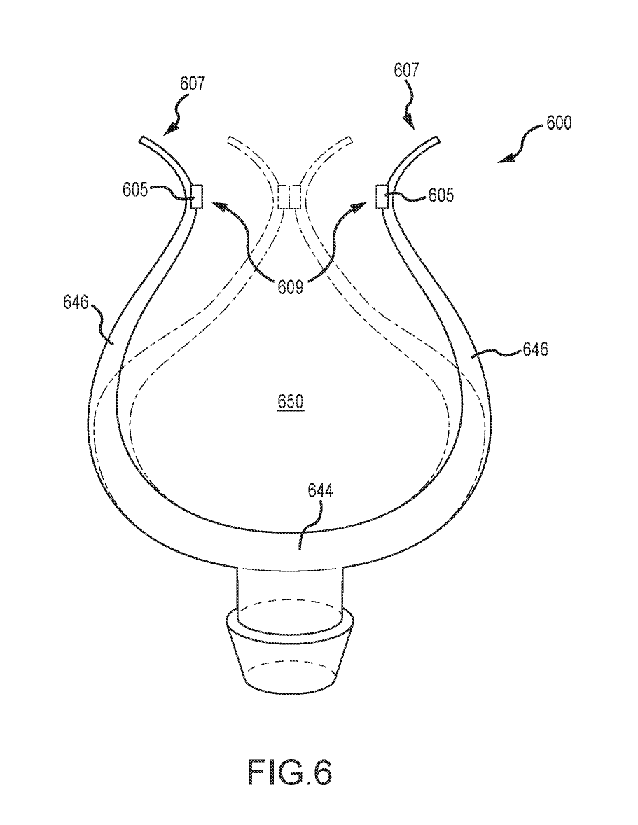

The cable cradle 234 may also be formed as a single piece from a flexible material. The cable cradle may be shaped like a horseshoe or resemble an upside down Greek letter Omega as shown in FIG. 6. The horseshoe shaped cradle 600 may include a semi-circular lower portion 644 and upwardly extending flexible prongs 646 that terminate at outwardly projecting ends 607. The lower portion 644 may be made of the same flexible material as the prongs 646, but have a larger cross-sectional area, such that the lower portion 644 is more rigid than the prongs 646. The prongs may be S-shaped, as shown in FIG. 6, or of some other shape, such as a C-shape. At an upper, inwardly curving portion 609 of the prongs 646, there may be a releasable connection 605. The releasable connection 605 may incorporate magnets, a tab and slot or groove to secure the tab in, a twist clip, or some other releasable connection. When the releasable connection 605 is disconnected, one or more cables can easily be placed in the cradle 600. When the two prongs 646 are connected via the releasable connection 605, as seen by the dotted lines in FIG. 6, then an area 650, through which the one or more cables are placed, is enclosed. Other configurations for a flexible cable cradle 600 which can accept cables and help support and retain the cables are contemplated. The flexible cable cradle 600 may be incorporated with any other embodiment of a cable support structure.

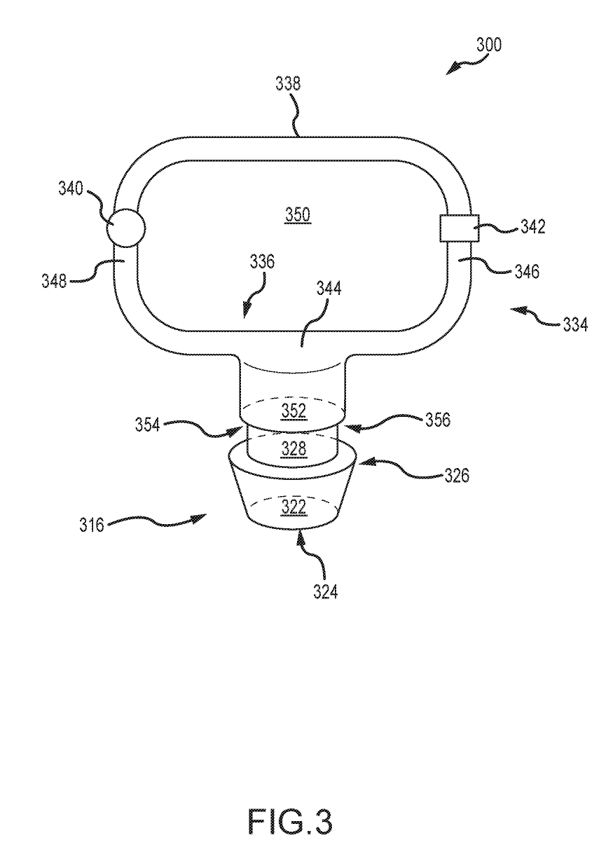

In a second example embodiment, as shown in FIG. 3, the cable support structure 300 may have a single connection system at the insert 316. As seen in the figure, the cable support structure 300 is capable of coupling to a safety cone by way of the insert 316 that can be inserted into an opening at the top or vertex of a safety cone. The insert 316 may include an end or portion shaped like a frustum 322. The frustum 322 has a cross-sectional area that increases from a smaller bottom end 324 to a larger top end 326. The cross-sectional area of the top end 326 is larger than an opening in a safety cone so that some force is required to insert the frustum 322 into the top opening of the safety cone. The larger cross-sectional area of the top end 326 also requires some force to pull free of the opening.

At the top end 326 of the frustum 322 there is an annular recess or channel 328 that may snap into a corresponding annular flange defined in the opening of the safety cone. At the top end 354 of the annular channel 328 there is a vertical support 352. The cross-sectional area of the vertical support 352 is larger than the cross-sectional area of an opening in the top of a safety cone. The vertical support 352 creates a second step or ledge 356 that prevents the insert 316 from being pushed further into the opening of a safety cone. The frustum 322 and/or annular channel 328 may be dimensioned to provide an interference fit with the cone to hold the support 300 stably in place.

The vertical support 352 extends upwards from the upper end 354 of the annular channel 328 and supports a cable cradle 334. The cable cradle 334 has the same general shape and configuration as the cable cradle 234 in FIG. 2. Specifically, the cable cradle 334 may include a base section 336, a retainer 338, a hinge 340, and a latch mechanism 342. The base section 336 can be saddle shaped in order to support and retain one or more cables in the cradle 334. The base section 336 has a crosspiece 344 with upwardly extending prongs 346,348 at either end of the crosspiece 344. The hinge 340 is joined to a first of the two upwardly extending prongs 348 and the latch is joined to the second of the two upwardly extending prongs 346. The retainer 338 may be an inverted saddle shape that mirrors the base section 336. The retainer 338 is pivotally connected to the base section 336 at the hinge 340 and is securable at the latch 342 when the retainer 338 is pivoted relative to the base section 336.

In a closed configuration, the retainer 338 and base section 336 are pivotally connected at the hinge 340 and secured at the latch 342 such that they enclose an area 350. The cables are supported by the base section 336 and the retainer helps retain the cables within the area 350. In an open configuration, the retainer 338 and base section 336 are pivotally connected at the hinge 340 but are not contacting at the latch 342. The open configuration allows the support structure 334 to provide support for the cables. The open configuration also allows the placement of cables into the area 350 through the opening between the non-contacting ends of the base section 336 and retainer 338 at the latch 342.

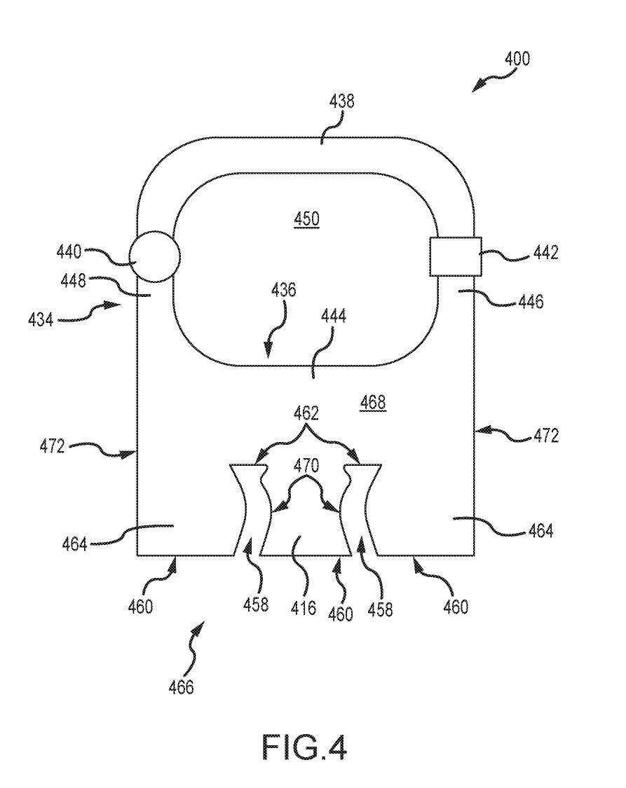

FIG. 4 illustrates a third example embodiment of a cable support structure 400. This embodiment may include a coupling end or portion 466, a transition section or portion 468, and a cable cradle 434 opposite the coupling portion 466. The coupling portion 466 and transition portion 468 may be flat planar members. The coupling portion 466 may include an insert 416, two channels, slots, or grooves 458, and two external members 464 on lateral sides of the insert 416. The insert 416 is located in between the two external members 464 and also between the slots 458. The slots 458 begin at a bottom edge 460 of the coupling portion 466 and extend towards the transition portion 468 and terminate at an end 462. There are many possible shapes contemplated for the channels 458, one of which is shown in FIG. 4. The channels or slots 458 can initially angle or be directed towards the center of the coupling portion until a point 470 where the channels 458 change direction and extend in a direction towards the lateral edges 472 of the coupling portion 466. The shape of the channels 458 allows for the insert 416 to be inserted in an opening at a top or vertex of a safety cone. The curved shape of the channels 458 deforms the walls of a safety cone as the insert 416 is inserted in an opening at a top of a safety cone. The deformation of the safety cone walls supports and secures the coupling portion 466 of the cable support structure 400.

The transition portion 468 extends towards the cable cradle 434 from the coupling portion 466 and may include a planar or differently shaped member. The cable cradle 434 has the same general shape and configuration of the cable cradle 234 in FIG. 2. Namely, the cable cradle 434 includes a base support 436, a retaining bar 438, a pivotal connection 440, and a releasable connection 442. The base support 436 is U-shaped, with a spar 444 and two spurs 446,448 which extend upwardly from either end of the spar. The retaining bar 438 is joined to a first spur 448 by a pivotal connection 440 such that the retaining bar 438 can pivot relative to the base support 436. In one configuration, the retaining bar 438 can be pivoted relative to the base support 436 such that the retaining bar 438 also contacts the second spur 446 and is optionally secured at the releasable connection 442. The retaining bar 438 may mirror the shape of the base support 436.

In a second configuration, the retaining bar 438 is pivoted or rotated relative to the base support 436 at the pivotal connection 440 such that the retaining bar 438 does not contact the second spur 446. Because the retaining bar 438 and second spur 446 do not contact, the cable cradle 434 is open to allow one or more cables to be laid in the area 450.

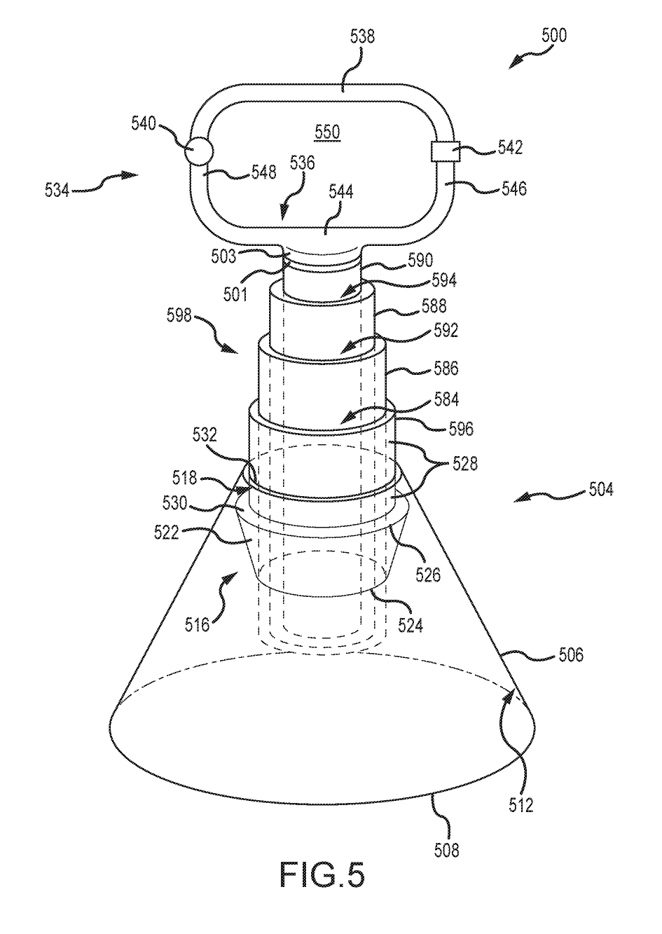

In another example embodiment, as illustrated in FIG. 5, the cable support structure 500 may include a height adjustable support 598. In certain instances, a base 504 of the support structure 500 is generally the same shape and configuration as the base 204 of the support structure 200 in FIG. 2. Specifically, the base 504 may include a conical frustum 506 with an open bottom end 508 that allows the conical frustum to engage an internal surface 512 of the conical frustum 506 on an external surface of a safety cone.

The base 504 may also include an insert 516, which extends from an upper internal surface 518 of the conical frustum 506 towards the open bottom end 508. The insert 516 can be shaped like a frustum, bulb, or some other shape that has a cross-sectional area that increases from a smaller bottom end 524 to a larger top end 526. The cross-sectional area of the top end 526 is larger than an opening in a safety cone so that some force is required to push the insert 516 into the top opening of the safety cone. The larger cross-sectional area of the top end 526 also requires some force to pull the insert free of the opening. At the top end 526 of the frustum 522 there is a vertical column 528 which has a smaller cross-sectional area than the top end 526 of the frustum 522. The vertical column 528 is connected or joined to an upper end 532 of the conical frustum 506 at a point above the top or vertex of the safety cone.

The vertical column 528 extends upwardly from the upper end 532 of the conical frustum 506 towards an upper end 596. There is an opening 584 that extends through the insert 516 and column 528 from the bottom end 524 of the frustum 522 to the top end 584 of the column. The opening 584 allows for a hollow tube 586 to slide vertically. The hollow tube 586 can be releasably fixed at whatever height may be required for a given installation via any known mechanism in the art. The opening 592 of the hollow tube 586 further allows a second hollow tube 588 to slide vertically and extend upwards. Nested inside the opening 594 of the second hollow tube 588 is a stanchion 590. The respective tubes may be telescoped and fixed relative to each other at the height by various possible mechanisms such as a ball detent, interference fit, locking pin, twist lock, cam lock, threaded connection, collar clamp, or other such mechanism. The nested column 528, hollow tube 586, second hollow tube 588, and stanchion 590, form a telescoping height adjustable support 598 which allows the cable cradle 534 to be positioned at varying heights. Although the height adjustable support 598 in FIG. 5 is shown with three telescoping sections, differing numbers of telescoping sections are contemplated.

A joint 501 that moves about an axis can be incorporated into the height adjustable support 598 or other support embodiment. Although a rotating joint 501 is illustrated at a top end 503 of the height adjustable support 598, other positions are possible. The rotating joint 501 allows the cable cradle 534 to rotate or pivot relative to the base 504. This rotation allows cables to be extracted from the opening 550 of the cable cradle in a wider range of directions without subjecting the cables to additional stresses from bending. The rotating joint may include a bearing or other pivoting connection.

The rotating joint 501 supports a cable cradle 534. The cable cradle 534 has the same general shape and configuration as the cable cradle 234 in FIG. 2. In particular, the cable cradle 534 may include an underlying support 536, a catch 538, a pivoting joint 540, and a fastening mechanism 542. The underlying support 536 is configured as a forked shape in order to support and retain one or more cables in the cradle 534. The underlying support 536 has upwardly extending prongs 546,548 that extend from either end of a cross bar 544. The pivoting joint 540 rotationally connects a first of the two upwardly extending prongs 548 and the catch 538. The fastening mechanism 542 is connected to the second of the two upwardly extending prongs 546 and optionally connectable to the catch 538. The catch 538 may mirror the shape of the underlying support 536.

In a first configuration, the catch 538 and underlying support 536 are pivoted or rotated relative to each other such that they enclose an area 550. In this configuration, the fastening mechanism 542 can alternately secure or fasten the catch 538 and underlying support 536 together. This configuration allows the underlying support 536 to support and retain one or more cables and the catch 538 helps prevent the cables from falling out of the area 550.

In a second configuration, one or more cables can be either introduced or removed from the area 550. In this configuration, the catch 538 and underlying support 536 are only in contact at the pivoting joint 540. This allows cables to be introduced to or removed from the area 550 through a gap between the catch 538 and the underlying support 536 at the end of the second prong 546.

Although several specific embodiments of the disclosure have been described herein, those skilled in the art could make changes to the disclosed embodiments without varying or departing from the scope of the disclosure. Any directional references included in the description are only meant to aid the reader's understanding of the disclosure and are not limitations on the disclosure unless described as such. Furthermore, any joints or connections are meant to be construed broadly and may include intermediate members between a connection of elements and relative movement between elements.

Although the present disclosure has been described with reference to various specific embodiments, it will be understood that these embodiments are illustrative examples and that the scope of this disclosure is not limited to them. Many possible variations, modifications, improvements, alterations, and additions to the present disclosure are possible. These variations, modifications, improvements, alterations, and additions may fall within the scope of this disclosure as defined in the claims that follow. It is intended that everything contained in the description or drawings shall be interpreted as illustrative only and not limiting. Changes in detail or structure may be made without departing from the disclosure as defined in the claims which follow.

1. A cable support device comprising:
a first member comprising a base portion, a first portion, and a second portion spaced apart from the first portion, the first portion and the second portion extending upwards from opposite ends of the base portion; and
a support member downwardly extending from the base portion of the first member and configured to couple with a safety cone, wherein the support member comprises:
a post, connected to the base portion at an upper end of the post and to a lower member at a lower end of the post, wherein an upper portion of the lower member defines a ledge; and
a hollow conical member connected to the post at a connection position that defines a space between the connection position and the ledge.

2. The cable support device of claim 1, wherein the support member is height-adjustable.

3. The cable support device of claim 2, wherein the support member further comprises a moveable rod configured to slide relative to the bottom portion and a clamp that secures the moveable rod at a given height.

4. The cable support device of claim 2, wherein the support member further comprises tapered telescoping hollow tubes configured to form an interference fit with each other to maintain a given height.

5. The cable support device of claim 1, wherein the base portion, the first portion, and the second portion together form a u-shaped structure and partially enclose an area.

6. The cable support device of claim 1, further comprising a second member pivotally connected to the first portion and configured to be secured to the second portion.

7. The cable support device of claim 1, wherein the support member further comprises a joint configured to move about an axis.

8. The cable support device of claim 1, wherein the support member further comprises a moveable rod with a plurality of holes positioned longitudinally on the moveable rod, each of the plurality of holes configured to receive a pin, the pin extending beyond a wall of the moveable rod and interfacing with the support member to secure a height of the moveable rod relative to the bottom portion.

9. The cable support device of claim 1, wherein the post and the lower member of the support member comprises an insert receivable in an opening of the safety cone.

10. The cable support device of claim 9, wherein the hollow conical member comprises a bottom opening configured to receive and overlay a vertex of the safety cone.

11. The cable support device of claim 10, wherein the insert is positioned on an inner side of the conical structure and a lower portion of the lower member has a cross-sectional surface area that is less than the upper portion.

12. The cable support device of claim 11, wherein the lower member comprises a member having a frustum-shape.

13. The cable support device of claim 1, wherein the hollow conical member comprises a bottom opening configured to receive and overlay a vertex of the safety cone.

14. The cable support device of claim 1, wherein the support member is coupled to the safety cone by an interference fit.

15. The cable support device of claim 1, wherein the first member and the support member define a substantially planar member.

16. The cable support device of claim 15, wherein the bottom portion comprises an insert receivable in an opening of the safety cone.

17. The cable support device of claim 16, wherein the bottom portion further comprises a first and a second slot, the insert positioned between the first and second slot.

18. The cable support device of claim 16, further comprising a second member pivotally connected to the first portion and configured to be secured to the second portion.
